(19) United States
(12) Patent Application Publication
(10) Pub. No.: US 2009/0234827 A1
(43) Pub. Date: Sep. 17, 2009

(54) CITIZENSHIP FRAUD TARGETING SYSTEM

(76) Inventors: Mark Gercenstein, Potomac Falls, VA (US); Kevin Campbell, Springfield, VA (US); Kenneth Russo, Phoenixville, PA (US); Ahmad Salman Aziz, Centerville, VA (US)

Correspondence Address: UNISYS CORPORATION, UNISYS WAY, MAIL STATION: E8-114, BLUE BELL, PA, 19424, US

(21) Appl. No.: 12/036,615

(22) Filed: Mar. 14, 2008

(51) Int. Cl. G06F 17/30

(52) U.S. Cl. 707/5

(57) ABSTRACT

Methods and systems for biographic scoring are disclosed. One system includes a biographic scoring module that applies one or more scoring rules to each of a plurality of biographic records to generate a score associated with each of the plurality of biographic records. The system also includes a result generation module that generates a report based on one or more scores generated by the biographic scoring module. The methods and systems disclosed can, in certain cases, reflect a likelihood that an individual associated with the biographic record is an unauthorized alien.

### TECHNICAL FIELD

The present disclosure relates generally to methods and systems for evaluating personal records to detect citizenship fraud. More specifically, the present disclosure relates to citizenship fraud targeting systems and methods.

### BACKGROUND

There are currently three hundred thousand illegal alien residents incarcerated in jails and prisons in the United States at any one time. Annually, the total number of bookings in state and local jails is estimated to be well over two million. Within the U.S. jail population, the United States Department of Immigration and Customs Enforcement (ICE) attempts to identify criminal aliens, who may be subject to deportation.

When criminals are placed in a jail, a booking agent collects biographic and biometric information from that person, including name, religion, nationality, social security number, fingerprints, and other information. However, often this information is not available to the booking agent or is inaccurate, either due to the criminal providing false (e.g. fraudulent) information or due to the criminal's failure to provide any information.

The current process used by ICE to identify and deport criminal aliens relies on manual operation involving agents visiting a small number of jails and performing a “hit or miss” inspection of jails and booking records at those jails. ICE agents visit jails to spot check those facilities for criminal aliens. These visited jails tend to be clustered around large metropolitan areas. The jails visited by ICE agents are thought to represent less than 2% of all facilities. Therefore, certain jails are not checked at all for criminal aliens, allowing those individuals to remain undetected. For example, in 2004 ICE identified and deported only about 80,000 criminal aliens. This represented less than about 5% of an estimated total population of criminal aliens in jails during that year.

In addition, a typical ICE agent averages only 3 screens of possible incarcerated aliens per day due to the lack of automated data mining techniques, shortage of agents, and shortages of other resources. Therefore, even were a large number of criminal aliens suspected, limited resources prevent efficient investigation.

For these and other reasons, improvements are desirable.

### SUMMARY

In accordance with the following disclosure, the above and other problems are solved by the following:

In a first aspect, a biographic scoring system is disclosed. The system includes a biographic scoring module that applies one or more scoring rules to each of a plurality of biographic records to generate a score associated with each of the plurality of biographic records. The system also includes a result generation module that generates a report based on one or more scores generated by the biographic scoring module. The system generates scores which reflect a likelihood that an individual associated with the biographic record is an unauthorized alien.

In a second aspect, a citizenship fraud detection and targeting system is disclosed. The system includes a biographic scoring system communicatively connected to a network, the biographic scoring system configured to receive biographic records from an biographic data server. The biographic scoring system is further configured to apply one or more scoring rules to each of a plurality of the biographic records to generate a score associated with each of the plurality of biographic records. The biographic scoring system is further configured to generate a report based on one or more of the scores. The one or more scores reflect a likelihood that individuals associated with the corresponding biographic records are unauthorized aliens.

In a third aspect, a method of identifying unauthorized aliens is disclosed. The method includes scoring one or more biographic records with one or more scoring rules to generate a score corresponding to each of the one or more biographic records. The method further includes generating a report based on one or more of the scores. The report relates to a likelihood that one or more of the biographic records corresponds to an unauthorized alien.

### BRIEF DESCRIPTION OF THE DRAWINGS

FIG. 1 is a logical diagram of a network in which aspects of the present disclosure can be implemented;

FIG. 2 illustrates a general purpose computing system for use in implementing as one or more computing systems of the present disclosure;

FIG. 3 illustrates an example data sharing network used to implement aspects of the present disclosure;

FIG. 4 is a logical block diagram of software systems used to implement a biographic scoring system according to a possible embodiment of the present disclosure; and

FIG. 5 shows an example user interface displaying criteria used to score potential unauthorized non-citizens in an citizenship fraud targeting system, according to a possible embodiment of the present disclosure;

FIG. 6 shows an example user interface displaying a biographic record analyzed using the citizenship fraud targeting system of the present disclosure;

FIG. 7 shows an example user interface displaying status information relating to an citizenship fraud targeting system, according to a possible embodiment of the present disclosure; and

FIG. 8 is a flowchart of methods and systems for targeting citizenship fraud according to a possible embodiment of the present disclosure.

### DETAILED DESCRIPTION

Various embodiments of the present disclosure will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits.

In general, the present disclosure relates to identifying citizenship fraud and alien targeting systems, and methods of using/operating such a system. The system generally receives biographic data, such as data collected by a booking agent at a jail, and performs a scoring algorithm on that data to determine a likelihood that the person under review is an unauthorized alien, i.e. not a United States citizen. That information can be used to prioritize investigations into unauthorized aliens, allowing ICE agents or other law enforcement officials to conduct these investigations and deportation proceedings much more efficiently (i.e. by focusing investigations on individuals having a higher likelihood of being aliens).

Although the present disclosure describes the citizenship fraud detection system using an example of inmate data received by booking agents in a jail, it is understood that the systems and methods of the present disclosure are not so limited. For example, analogous systems can be applied in the context of state and local records, such as are collected in the context of drivers' license applications, mortgage applications, or local applications for municipal services. Other possibilities exist as well.

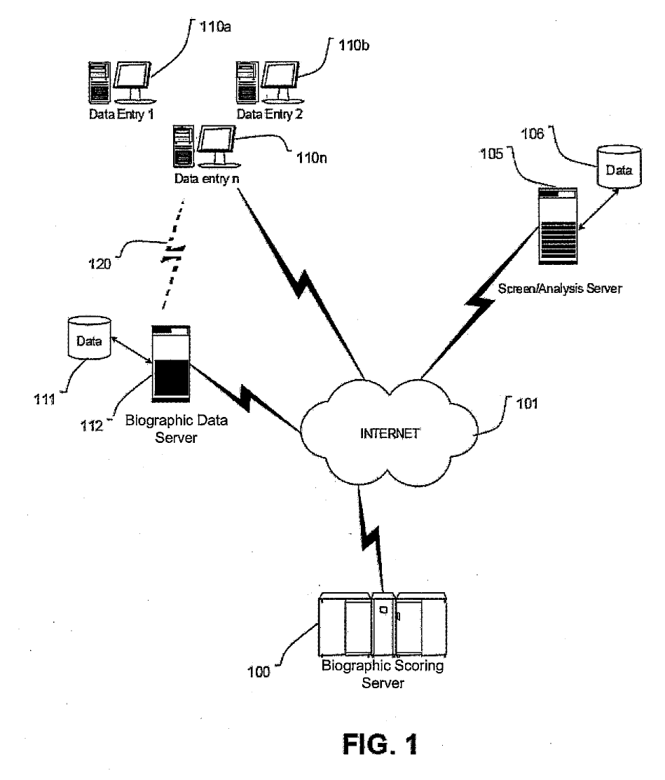

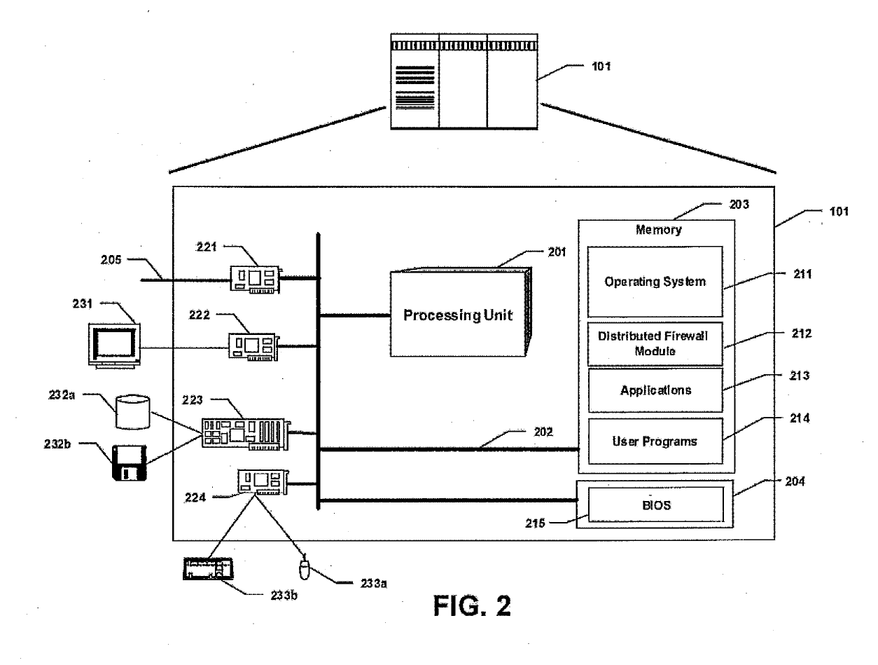

FIG. 1 is a logical diagram of a network in which aspects of the present disclosure can be implemented. The network includes a biographic scoring server 100, which is communicatively connected to a network, such as the Internet 101. The biographic scoring server 100 can be, in various embodiments, any of a number of types of specialized or generalized computing systems, an example of which is described below in conjunction with FIG. 2. The biographic scoring server 100 hosts a web based application that analyzes biographic records received from a variety of institutions, such as state or federal agencies. In an example system, the biographic scoring server 100 receives records from multiple jails to identify the legal status of inmates at those jails.

The biographic scoring system 100 implements an algorithm using the biographic data elements gathered about individuals and generates a list of highly probable fraudulent records, which correspond to potentially fraudulent citizenship records. In the case of inmate records received from jails, the biographic scoring server analyzes records received relating to the inmate population from the jails whose data is being analyzed. The biographic scoring server 100 generally executes a number of scoring rules on those records to determine likely individuals who are aliens. The biographic scoring server 100 can generate reports based on those scores as well, and provide those reports to users. The users can take these reports and perform further investigations regarding the identified individuals and agencies, such as investigating and/or deporting individuals, as appropriate.

The data elements gathered about can vary in different implementations of the overall system, based on the types of data to be tracked related to the biographic records that are tracked. In certain embodiments, such as for inmates in jails, an inmate record can include an inmate identification number, first name, last name, date of birth, social security number, religion, nationality, U.S. residency status, occupation, physical features, place of birth, race, marital status, mental capacity, existence/presence of tattoos, religion, or other physical identification characteristics.

An analysis server 105 is also connected to the Internet 101 or other similar network, and performs a secondary analysis and screening of data. The analysis server 105 can also be any type of computing system, such as the system shown in FIG. 2. The analysis server 105 operates on data 106, which is preferably located locally to the server 105. The data 106 generally includes a number of biographic records identified as potentially including unauthorized aliens. The data 106 can also include various additional data collected from various publicly available or commercially available sources, such as property and tax records, phone records, or other information. The analysis server 105 reviews the biographic records and performs specific validation steps on that data, such as verifying that the data is consistent with the publicly or commercially available information. The analysis server 105 can execute a number of rules on the data to ensure that the information provided by the individual, (e.g. an inmate when booked or an individual applying for government services) is consistent with data available from the publicly or commercially available data sources (e.g. property records, phone listings, etc.). The rules are used to validate the information provided by the individual, and can include verifying or adding a phone number, address (city, state, zip codes), verifying first and last names, and verifying a social security number and/or date of birth. Other rules can be used as well.

Each rule run on a biographic record corresponds to a resulting validation determination regarding one or more portions of the biographic record, and each of those validation determinations is assigned a shorthand code by the analysis server 105. For example, a determination that the biographic record has a wrong or false address could be assigned a first unique code, while a determination that the biographic record has a correct address could have a second code. Similar unique codes can be established for each data entry in the biographic record, and each validation step performed thereon.

A plurality of data entry systems 110a-n allow users, such as booking agents at a jail, agents voluntarily receiving applications, inter alia, to enter data into the biographic records, which are stored in a database 111 that is associated with a biographic data server 112. The data entry systems are interconnected with the biographic data server 112 via a secure communication connection 120, such as through an intranet or other local network or in a secure (non-public) distributed system.

The data entry systems 110a-n also allow users having different security rights to access, view, and edit information in the biographic scoring server 100. The users can include immigration (ICE) agents, managers, and other law enforcement and prison officials. Some of these users, such as ICE management, are authorized to access information and edit the scoring algorithms in the biographic scoring server. Other users, having lower access authorization, may view biographic records, but cannot edit scoring algorithms. Other individuals, who are not users, are prevented from accessing information altogether.

In certain embodiments, the biographic scoring server 100 is a web server which allows user access to various reports regarding inmates whose inmate records have been stored, processed, and scored by the biographic scoring server. In these embodiments, the web server can provide the various user interfaces and reports for display on a remote computing system, such as one of the data entry systems 110a-n.

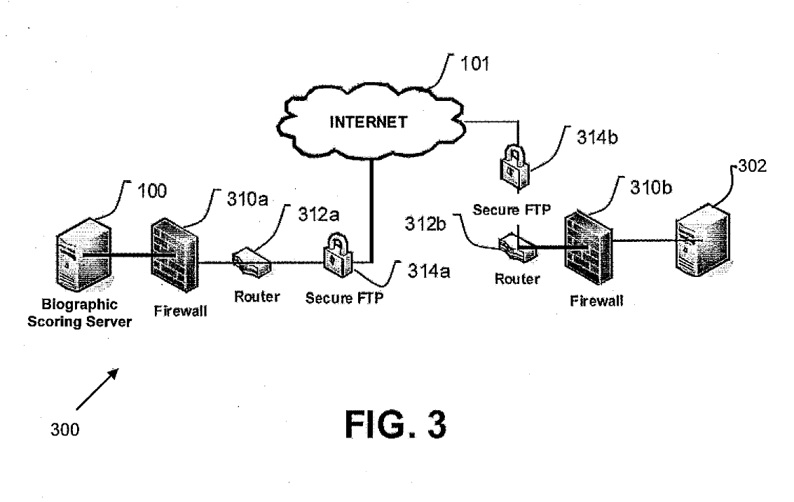

In use, the overall system operates to collect and coordinate information received from individuals, and assists in identifying unauthorized aliens who may be subject to deportation using that information. The various data entry systems 110a-n can be used by state records employees, booking agents or other law enforcement professionals to enter information regarding inmates into the database 111, or to alter one or more options regarding the scoring algorithm in the biographic scoring server 100 via user interfaces generated by that server. The biographic information collected by these users and entered into an biographic record can include the name, address, social security number, birthplace, birthdate, religion, citizenship, and other information previously mentioned. This information may be determined by a review of an identification card of the individual, or may be self-reported. The database 111 therefore contains, after data intake, a collection of self-reported information related to the individuals (e.g. inmates and inmate records), accessible through the Internet 101 via access to the inmate data server 112. The biographic scoring server 100 requests or receives a collection of the data from the database 111, and performs a first review of that data. A possible architecture for communications between the inmate data server 112 and the inmate scoring server 100 is illustrated in FIG. 3, described in detail below.

The first review of data can correspond to eliminating records clearly corresponding to resident individuals, such as records which have previously been checked or otherwise have been verified as accurately indicating United States citizenship. The biographic scoring server 100 can then transmit some or all of the data received from the database 111 and biographic data server 112 to the analysis server 105. Communications between the biographic scoring server 100 and the analysis server 105 can be accomplished using one or more of the mechanisms described in FIG. 3 as well.

The analysis server 105 executes one or more rules on each record to compare the biographic data to publicly or commercially available information to validate the biographic data. For example, the analysis server 105 can verify that the social security number of the individual is correct, can determine whether the given home address of the individual is in fact a valid address, can verify the date of birth of the individual, can check the given phone number of the individual against phone records, or can perform additional validation tests. The analysis server 105 can augment the data received from the biographic scoring server 100 with additional information relating to the validation steps performed, such as by incorporating status codes alongside information entries in the biographic record. The status codes can be included with the record, or linked thereto with a unique identifier. The status codes are then returned to the biographic scoring server 100, such as by transmitting the codes for linking by the biographic scoring server or by linking the codes with records in the analysis server 105 and returning that information as a whole to the biographic scoring server.

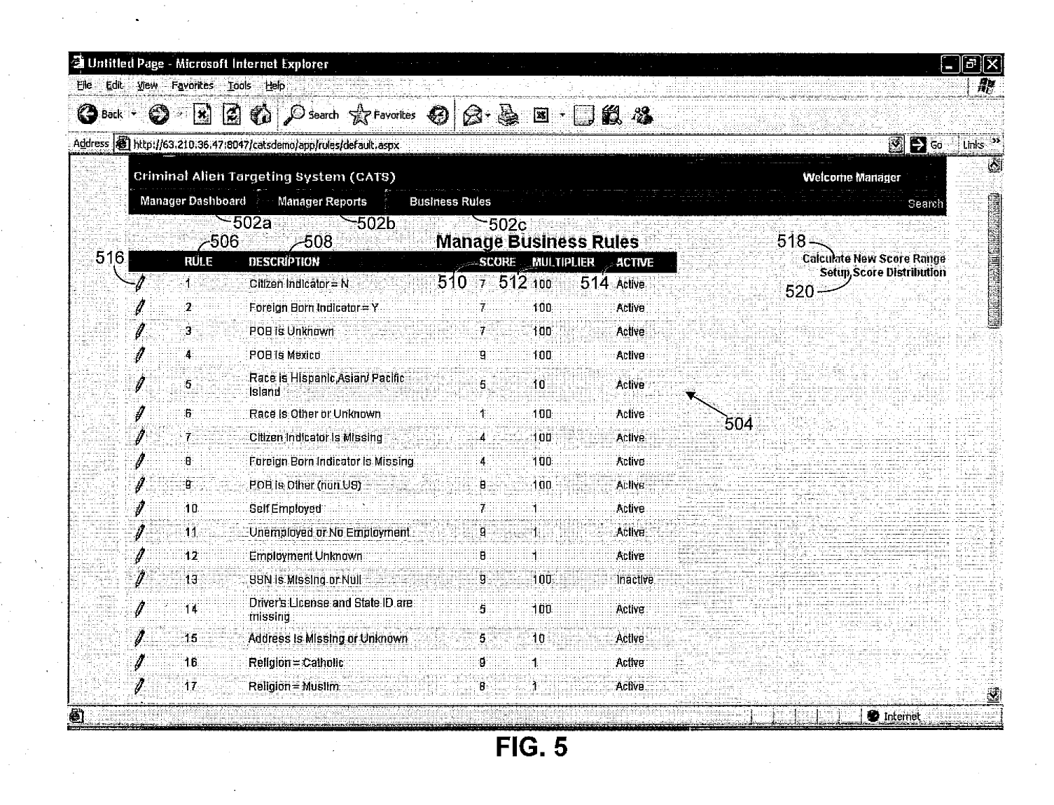

When the biographic scoring server 100 then receives the augmented/validated records or codes from the analysis server 105, it can perform a scoring algorithm on those records and codes to establish a likelihood that any given record corresponds to a non-citizen of the United States, i.e. an unauthorized alien. The scoring algorithm applies rules to each record (including the linked validation codes), with pre-established values assigned to each possible anomaly detected in a record which would tend to establish that the individual is not a United States citizen. Example rules would provide values and weights to certain characteristics or events detected, such as providing a false name or address, having a valid but inconsistent social security number, being unemployed, or other factors tending to indicate that the individual is not a citizen. Additional example rules are displayed in the user interface shown in FIG. 5.

In certain embodiments, the biographic scoring server 100 categorizes the biographic records into one or more categories, based on the likelihood that the individual is or is not a United States citizen or authorized alien. In such embodiments, a user of the overall system having access to the rules on the biographic scoring server 100 can set thresholds for establishing scores defining the various categories. For example, a high score as determined by the rules in the biographic scoring server 100 could correspond to a high likelihood that the individual is in fact an unauthorized alien, and would be grouped with other biographic records having high scores into a category of individuals with a high likelihood of unauthorized alien status. Conversely, low scores could correspond to a low likelihood that the inmates are aliens (i.e. high likelihood of U.S. citizenship or legal aliens), and would be grouped accordingly. By grouping biographic records in this way, immigration and customs officials can focus their efforts on investigating individuals having a high probability that they are in fact unauthorized aliens.

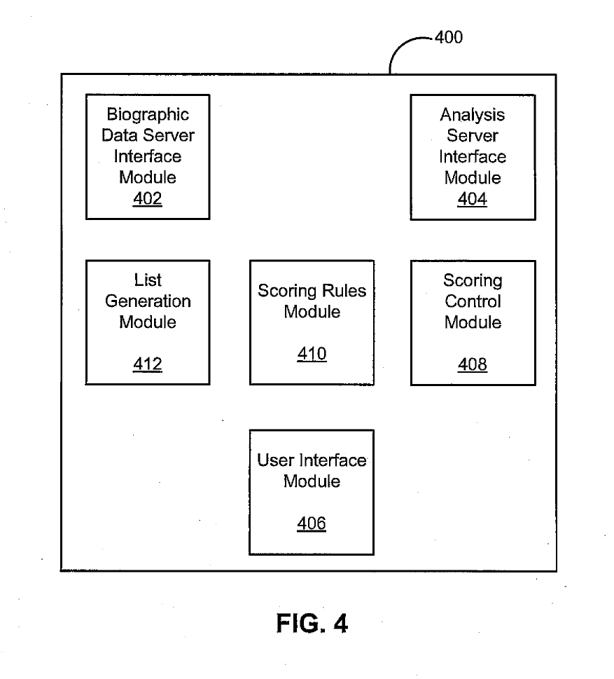

The biographic scoring server 100 can generate reports based on one or more of the scores and corresponding biographic records. The biographic scoring server 100 can also generate various user interfaces that display information related to an individual, or display rules used on the data, allowing an authorized user of the biographic scoring server 100 to adjust the scoring system used. In the case where the biographic scoring server 100 manages inmate records received from jails, the reports can display statistics related to inmates in jail comparing the number of probable aliens at each jail. Additional user interfaces and functionality can be incorporated into the system as well. Example user interfaces that can be delivered to a client computer from the biographic scoring server 100 are shown in FIGS. 4-6. The biographic scoring server 100 can generate user interfaces that can be used to display reports, allow user editing and creation of scoring criteria to be used, and display details of various individuals and associated institutions, as illustrated in FIGS. 4-6, below.

Referring now to FIG. 2, a general purpose computing system 200 is shown for use in implementing as one or more computing embodiments of the present disclosure. The computing system 200 includes a processor unit 201, a system memory 203, 204, and a system bus 202 that couples various system components including the system memory 203, 204 to the processor unit 201. The system bus 202 may be any of several types of bus structures including a memory bus or memory controller, a peripheral bus and a local bus using any of a variety of bus architectures. The system memory includes read only memory (ROM) 204 and random access memory (RAM) 203. The RAM 203 can store a number of operational instructions executable by the processor unit 201, including an operating system 211, a firewall module 212, various applications 213, and user programs 214. A basic input/output system 215 (BIOS), which contains basic routines that help transfer information between elements within the computing system 200, is stored in ROM 204.

The computing system 200 also includes a network adapter 221, a video adapter 222, a storage adapter 223, and an I/O adapter 224. The network adapter 221 provides a connection from the system bus 202 to a network connection 205, which can be any of a number of wired or wireless network or data connections, such as packet based wired IP connections, 802.11, RF, Infrared, or other types of local or wide area network connections. The video adapter 222 connects the system bus 202 and associated programmable circuit 201 to a display 231, such as a monitor or touch screen LCD panel. The display 231 can be internal or external, and typically can include other peripheral devices (not shown), such as speakers, printers, and handheld devices.

The storage adapter 224 interfaces to the system bus 202 and connects a data store 232a, such as a hard drive or other large data storage device, and a magnetic disk drive 232b for reading magnetic disks. Optionally, the system can also include an optical drive for reading from or writing to a removable optical disk such as a CD ROM, DVD, or other optical media. The data store 232a, magnetic disk drive 232b, and optional optical disk drive are connected to the system bus 202 by the storage adapter 223; however, in various other embodiments, separate interfaces may be used for each drive. The drives and their associated computer-readable media provide nonvolatile storage of computer readable instructions, data structures, programs, and other data for the computing system 200.

The I/O adapter 224 connects various peripherals, such as a mouse 233a and keyboard 233b. Additional peripheral devices may be incorporated as well. Examples of input devices might include a keyboard, mouse, microphone, joystick, game pad, satellite dish, scanner, digital camera, touch screen, and a telephone.

A computing device, such as computing system 200, typically includes at least some form of computer-readable media. Computer readable media can be any available media that can be accessed by the computing system 200. By way of example, and not limitation, computer-readable media might comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by the computing system 200.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as computer program product.

FIG. 3 illustrates a data sharing network 300 used to implement aspects of the present disclosure. The network 300 can provide an interface between the various computing systems present in the network of FIG. 1, above, and can establish secure communications of sensitive data among the various entities controlling, processing, analyzing, and scoring the data. This security is generally in place when transmitting biographic records due to privacy regulations relating to transmission/sharing of personal data, such as are outlined by the U.S. Privacy Act. In the particular embodiment shown, the data sharing network 300 is used to transmit data between the biographic scoring server 100 and another server 302 which could be, for example, the biographic data server 112 or the analysis server 105 of FIG. 1.

The network 300 operates using the Internet 101, and provides multiple layers of security at each server 100, 302 to ensure secure communications of sensitive data. The network 300 includes firewalls 310a-b, routers 312a-b, and FTP client software 314a-b at each end of the network to provide this security. The firewalls 310a-b prevent unauthorized access to biographic records and other data stored on one or both of the servers by unauthorized computer systems connected to the Internet 101. The routers 312a-b provide additional security features, such as various additional firewall features and data routing features.

The FTP client software 314a-b or other similar communications software can provide a client-server configuration between the servers 100, 302. In certain embodiments, the FTP software 314a associated with one server acts as an FTP client while the complementary FTP software acts as an FTP server, allowing the client system to log in to the server system and upload or download files. In such embodiments, the FTP software 314a-b may be configured to allow the FTP client software to log into the server hosting the FTP server software at any of a number of predetermined times, e.g., weekly, daily, hourly, or some other periodic basis.

When in use within the network of FIG. 1, the network 300 can be used to upload full data sets to the biographic scoring server 100 from the inmate data server 112. In such a system, the biographic data server 112 can have FTP server software 314b on it, which can use an asynchronous key-exchange protocol (e.g. PGP, x.509, other systems) and can provide any of a number of encryption mechanisms (e.g. SSH or other encryption) to be used for secure data transmission of inmate records between the biographic data server and the biographic scoring server 100. Additional encryption can be included as well, such as a system based on Triple-DES or Blowfish (128+ bit) encryption standards.

The biographic scoring server 100 can have FTP client software 314a installed, with complementary encryption/decryption software. Data files can be transmitted between the biographic scoring server 100 and the biographic data server 112 in a compressed (e.g. ZIP) or uncompressed format, encrypted for transfer. In such systems, data transferred between the biographic data server 112 and the biographic scoring server 100 can be transferred as a whole or using periodic updates.

In a possible embodiment of the network 300 in use in conjunction with the systems of FIG. 1, the biographic scoring server 100 can establish a connection with the biographic data server 112 using predetermined account and password information, or other authentication systems. The biographic scoring server 100 is connected to a source file directory on the biographic data server 112 in which data files available for download are stored. The biographic scoring server 100 determines which files to acquire (e.g. which it has not already downloaded) and pulls those files to a local directory, through the various levels of firewalls and security previously described. Optionally, the biographic scoring server 100 has a facility to poll the directory on the biographic data server 112 periodically in the case that no data files appropriate for download have been found. In certain systems, data is transferred immediately as individual records are updated.

Alternative embodiments may include direct transactions performed between the biographic scoring server 100, the biographic data server 112, the analysis server 105, or other servers in the network. In this embodiment, individual record transfers may be accomplished via web services or similar data messaging protocols for the purpose of moving data between these servers.

Biographic records transmitted between the biographic data server 112 and the biographic scoring server 100 can have any of a number of formats commonly understood by the computing systems. For example, the biographic records can be text files, XML messages, database entries, spreadsheet entries, or organized in other types of file storage structures. In one possible embodiment, the biographic records are combined and placed in a delimited text file, such as a pipe (|) delimited text file. Each biographic record can correspond to a line within the text file, with each position in a line corresponding to a particular aspect of an biographic record. For example, a line in a text file that is encrypted and transmitted across the network 300 could be arranged:
ID|First Name|Last Name|DOB|SSN|Street Address|City|State|Citizenship| . . .
   Other information can be incorporated into a biographic record as well, as previously described. These records can then be parsed at one or both ends of the system according to certain instructions, which may be transmitted in a separate control file. The data can be, once received, loaded into a database or other data storage structure.

A network, such as the network 300, can also be used to share data between the biographic scoring server 100 and the analysis server 105 of FIG. 1. In such an embodiment of the network 300, data (e.g. biographic records, processed data) is shared between the two servers, with the biographic scoring server 100 providing a number of biographic records to the analysis server 105, and the analysis server returning codes, optionally in conjunction with those records, back to the biographic scoring server. In this instance, the analysis server 105 and the biographic scoring server 100 can include FTP server software as the FTP software 314a-b, with each server configured to accept secure data transfer. Each of the servers can manage encryption in a manner analogous to that described as usable for the connection between the biographic scoring server 100 and the biographic data server 112.

Using the network 300, the biographic scoring server 100 generally initiates communication with the analysis server 105 once it has received data from the biographic data server 112. The biographic scoring server 100 and the analysis server 105 perform a series of data sharing operations, with the biographic scoring server 100 generally providing biographic records for access by the analysis server 105 and the analysis server providing in return (following the validation/processing operations as previously described) validation data corresponding to those records. The biographic records can be stored in any of a number of types of files, such as the pipe-delimited files described above. The validation data can be incorporated into the biographic records, or can be stored as a separate file of a format known to both the biographic scoring server and the analysis server. If the validation data is stored in a separate file from the biographic record, the validation data can be linked to the biographic data through use of a unique identifier assigned to that biographic record (e.g. an individual's identification number). The validation data can include, for example, data that indicates successful or unsuccessful verification of the data provided in each biographic record.

FIG. 4 is a logical block diagram of software systems used to implement an citizenship fraud scoring system 400 according to a possible embodiment of the present disclosure. The citizenship fraud scoring system 400 can, in certain embodiments, correspond to software executed on the biographic scoring server 100 of FIG. 1. The citizenship fraud scoring system 400 includes a number of modules for interfacing with external systems, including an biographic data interface module 402, an analysis server interface module 404, an user interface module 406. The citizenship fraud scoring system 400 also includes a number of modules operating to execute scoring rules on biographic records and validation data, as described in general in conjunction with FIG. 1. These modules includes an biographic scoring control module 408, a scoring rules module 410, and a list generation module 412.

The biographic data interface module 402 provides data coordination and scheduling of data sharing between the biographic scoring system and a biographic data server, such as the server 112 of FIG. 1. The biographic data interface module 402 operates to provide the biographic scoring server functionality described in conjunction with the network 300 of FIG. 3, including scheduling connection between the biographic scoring server 100 and the biographic data server 112, and controlling/requesting data transfer between the biographic data server and the biographic scoring server.

The analysis server interface module 404 likewise provides data coordination and scheduling of data sharing between the biographic scoring system and an analysis server, such as the analysis server 105 of FIG. 1. The analysis server interface module 404 provides biographic records to the analysis server 105, and receives validation information from the analysis server, coordinating timing of communication with the analysis server and file management relating to import of validation data. The analysis server interface module 404 coordinates scheduling of connection to the analysis server, and also security and encryption used to connect the analysis server with the biographic scoring server as described in conjunction with the network 300 of FIG. 3.

The user interface module 406 provides user access to the data stored and processed by the biographic scoring server. The user interface module 406 generates a variety of types of user interfaces allowing various users of differing security/access levels (e.g. wardens, booking agents, managers, etc.) to view reports generated by the citizenship fraud scoring system 400. Certain user interfaces can be presented to certain subsets of the authorized users, such as those user interfaces allowing the user to edit the scoring rules and overall categorizations of biographic records. Other user interfaces can be presented to all authorized users (e.g. all ICE agents or prison officials), allowing the users to view the current status of one or more biographic records and individuals related to those records.

The user interface module 406 includes a web server and a report generator, allowing users to control and access data on the biographic scoring server. The user interfaces presented by the user interface module 406 include, in various embodiments, interfaces allowing users to: view individual biographic records; view scoring rules executed by the biographic scoring system; edit scoring rules executed by the biographic scoring system (with appropriate permission); view individual biographic records and validation data; and view summaries of biographic records, categorized and aggregated by score. Other user interfaces may be included as well, with those shown in FIGS. 5-7 below intended to provide examples of possible user interfaces that can be generated by such a module.

The scoring control module 408 coordinates operation of the scoring rules module 410 and the list generation module 412 to score biographic records, control internal usage of biographic records and validation data, and generate reports relating to the scoring performed. The scoring rules module 410 stores and applies the various scoring rules included in the system 400 to biographic records and validation data to arrive at an overall score for each record. The scoring rules module serially applies the various rules, with each rule assessing a condition based on the biographic record and assigning a value and a weight to that condition.

For example, and using two of the example rules displayed in the user interface of FIG. 5, one or more rules can assess a condition based on the citizenship indicator in the biographic record. A first rule could test whether the citizen indicator is set to “no” indicating that the individual reported that they are not a U.S. citizen. This rule could have a first value (shown as “7” in the example user interface of FIG. 5) and a first magnitude (shown as “100”). A second rule could test whether the citizen indicator is missing, indicating that the individual did not report any citizenship. This rule also has a value (“4”) and a magnitude (“100”). Each of these rules would be applied to an biographic record. If the biographic record explicitly indicates that the individual is not a citizen, a first subscore (e.g. “700”) would be added to that individual's overall score, corresponding to the value and magnitude of the first rule. If the biographic record does not explicitly indicate any citizenship, a second subscore (e.g. “400”) would be added to the individual's overall score, relating to the assigned value and magnitude of the second rule.

All or some subset of the rules included in the scoring rules module 410 could be applied against each biographic record, as directed by a user of the system. The scoring rules module 410 coordinates with the user interface module 406 to display the scoring rules to users of the biographic scoring system. A user having appropriate access (e.g. a manager) is provided functionality to enable, disable, or adjust the value and magnitude of any of the one or more rules included in the system. Optionally, the scoring rules module 410 allows that user, in conjunction with the user interface module 406, to add or delete rules as well.

The list generation module 412 generates a listing or summary of individuals after the biographic records have been scored. The list generation module 412 can organize the listing in any of a variety of ways, based on individuals, institutions with which the individuals are associated (e.g. jails in which inmates are housed), or other schemes. The list generation module 412 coordinates with the user interface module 406 to display the individual's status to users of the biographic scoring system. The list generation module 412 also optionally collects for distribution both summary and detailed lists of individuals having a high probability that the individuals are aliens, such that the lists can be transmitted to the users of the citizenship fraud scoring system 400 to allow further investigation regarding the alien status of those individuals.

Additional modules can be incorporated into the citizenship fraud scoring system 400 as well, to extend the functionality of the system, such as incorporating the operations of the analysis server 105 into the scoring system.

FIG. 5 shows an example user interface 500 displaying criteria used to score individuals in a citizenship fraud targeting system according to a possible embodiment of the present disclosure. In the embodiment shown, the user interface 500 displays information relating to inmates in various jails, according to a possible embodiment of the present disclosure. The user interface 500 provides a listing of various rules that can be used to calculate a likelihood that one or more of the individuals considered based on that person's biographic record is an unauthorized alien of the United States. The user interface 500 includes tabs 502a-c, corresponding to a manager dashboard tab 502a, a manager report tab 502b, and a business rules tab 502c. In the embodiment shown, the business rules tab 502c is active.

When the business rules tab 502c is active, a listing of business rules 504 is displayed. The listing of business rules (i.e. scoring rules) presents to the user the business rules that will be run against each biographic record to determine an overall score for that biographic record (e.g. inmate record). Each rule has a number 506, a description 508, a score 510, a multiplier 512, and a status 514. The number 506 and description 508 provide a description of each rule, with the number corresponding to a unique number assigned to the rule and the description corresponding to a user-understandable description of the test preformed by that rule. The score 510 and multiplier 512 establish a relative value placed on the rule, with higher scores and multipliers corresponding to a higher likelihood that the rule identifies an unauthorized alien. The status 514 indicates whether the rule is currently active or inactive. If a rule is active, it will be run against each of the biographic records when the system is in operation. If a rule is not active, that rule will be skipped during the scoring process.

In certain embodiments, the user interface 500 allows authorized users, such as managers of an inmate scoring or citizenship fraud identification/targeting system, to add, delete, activate, deactivate, or alter the scoring rules. In such embodiments, an edit option 516 is incorporated with each scoring rule. A manager can edit one or more of the scoring rules through use of the edit option 516, which triggers a further user interface screen to appear (not shown), allowing that manager to edit the selected rule.

The user interface 500 optionally also includes a calculation link 518 and a setup score distribution link 520 within the business rules tab 502c. The calculation link 518 causes the system to calculate an overall new possible range of scores based on the currently defined rules to be executed by the system. The setup score distribution link 520 links the user to a further user interface (not shown) allowing the user to define one or more threshold levels, such as levels that define high, medium, and low likelihood groups for individuals being unauthorized aliens based on the score calculated from the biographic record corresponding to that individual. The threshold levels presented in the user interface linked to using the setup score distribution link 520 are defined at the minimum and maximum by the overall possible range of scores, as calculated by the system in response to selection of the calculation link 518.

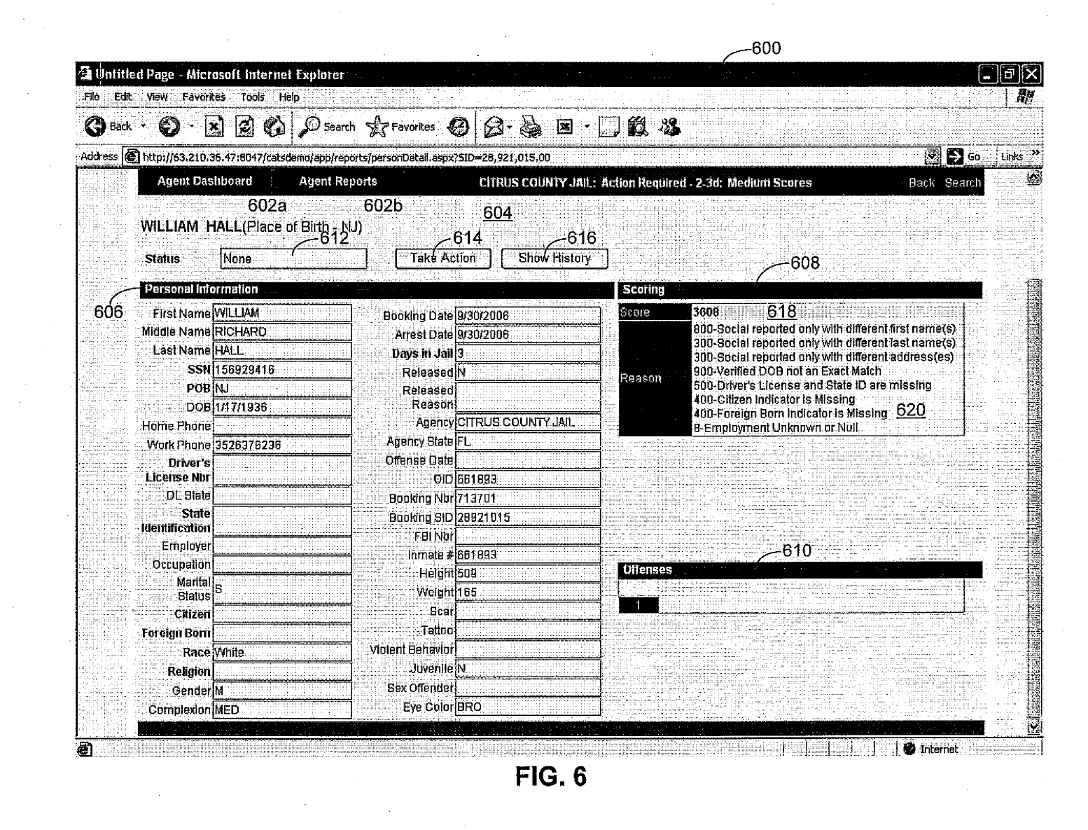

FIG. 6 shows a user interface 600 displaying an example record scored using the biographic scoring systems of the present disclosure. In the embodiment shown, the user interface 600 is a display viewable by a user (e.g. an ICE agent or other law inforcement official) relating to a biographic record of an inmate (i.e. an inmate record). The biographic information includes, for example, booking information collected from that inmate. The user interface 600 displays the information stored in a biographic record, the information received in a validation record, and scoring information to a user, illustrating the scoring performed on that biographic record. The interface 600 includes tabs 602a-b, shown as an agent dashboard tab 602a and an agent reports tab 602b. In the embodiment shown, the agent dashboard tab 602a is active.

The agent dashboard tab 602a includes an inmate status region 604, a personal information region 606, a scoring region 608, and an offenses region 610. The inmate status region 604 includes the inmate's name and place of birth, as well as a status field 612, an action button 614, and a history button 616. The status field 612 shows the current status of the inmate as determined by the user or agency assessing the inmate's biographic record. In the example shown, the status of an inmate is shown as “none” indicating that no action has been taken with respect to that particular inmate. Other status indicators could refer to a detainer issued, an investigation taking place, a deportation process taking place, or other actions taken by a person or agency reviewing the biographic record. The action button 614 triggers the appearance of another user interface (not shown) in which various actions can be designated in the biographic record. For example, if the user (e.g. an ICE agent) chooses to investigate the inmate further, the user can indicate that an investigation action is being initiated, which will subsequently be reflected in the status field 612. The show history button 616 triggers the appearance of a further user interface (not shown) in which all changes in the status of the inmate, along with information regarding the date, time, and outcome of the status change. Other information can be incorporated in the history of the inmate as well, such as changes to the scoring of that inmate's biographic record, changes to the biographic record itself, or other events.

The personal information region 606 provides an editable display of the biographic record, including the information elements that make up a biographic record. Although any of a number of different fields may appear based on the contents and structure of the biographic record, those fields are generally consistent among the biographic records; where individuals such as inmates do not provide information to the booking agent or the information is otherwise unknown, the fields of the biographic record are left blank.

The scoring region 608 includes an overall score 618 and a reason listing 620. The overall score 618 corresponds to the score determined by the scoring system based on operation of the one or more rules on the biographic record and validation data. The reason listing 620 lists each of the rules which accounted for a portion of the score assigned to the record, and the points attributed to each rule. The overall score 618 therefore corresponds to the sum of the individual rules listed in the reason listing 620.

The offenses region 610 lists available information about offenses committed by the inmate, as indicated by the booking agent, another officer, a court of law, or other person or entity.

Other regions can be included in the user interface 600. For example, an indicator region can be shown which illustrates which category of inmates the currently displayed biographic record would fall into (e.g., high likelihood of alien status, medium likelihood of alien status, low likelihood of alien status).

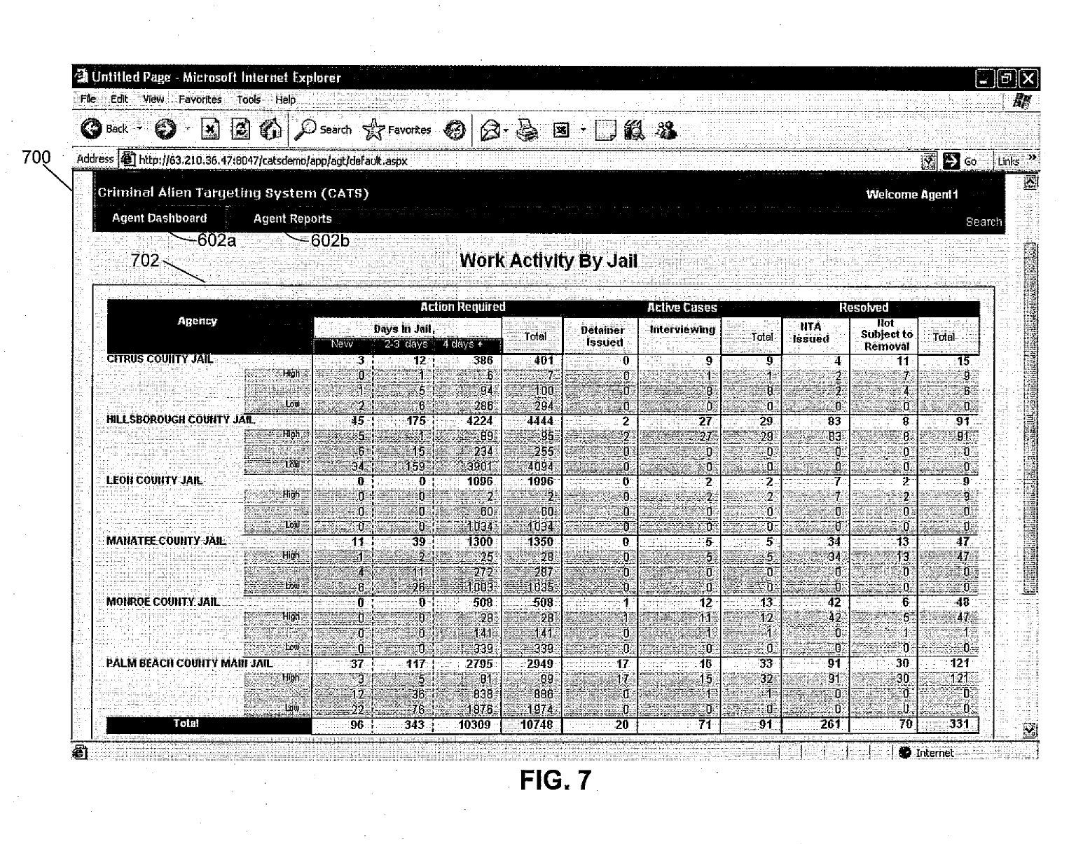

FIG. 7 shows an example user interface 700 displaying status information relating to a citizenship fraud targeting system, according to a possible embodiment of the present disclosure. The user interface 700 as shown is in use with a variety of biographic records of inmates resident in a number of jails. The user interface 700 illustrates a results summary generated by a biographic scoring system, categorized into groups based on a likelihood that the various inmates are unauthorized aliens. The user interface 700 displays a report of work activity by jail, as available via the agent reports tab 602b (described above in FIG. 6). The agent reports tab 602b displays a table 702 listing the various agencies (jails) from which inmates records are received, and lists, for each of the jails, the number of inmates in that jail and categorizes each inmate based on his/her likelihood to be an unauthorized alien. The table 702 also includes information regarding actions taken by users of the inmate scoring system, who can be immigration and customs enforcement officials or law enforcement officers working in connection therewith. In the embodiment shown, resolved and unresolved investigation status information is shown, including detainers, interviews held, notices to appear (NTAs) issued, and circumstances in which the investigated inmate is not subject to removal. Other information regarding investigations into inmates can be tracked using the user interface 700 as well.

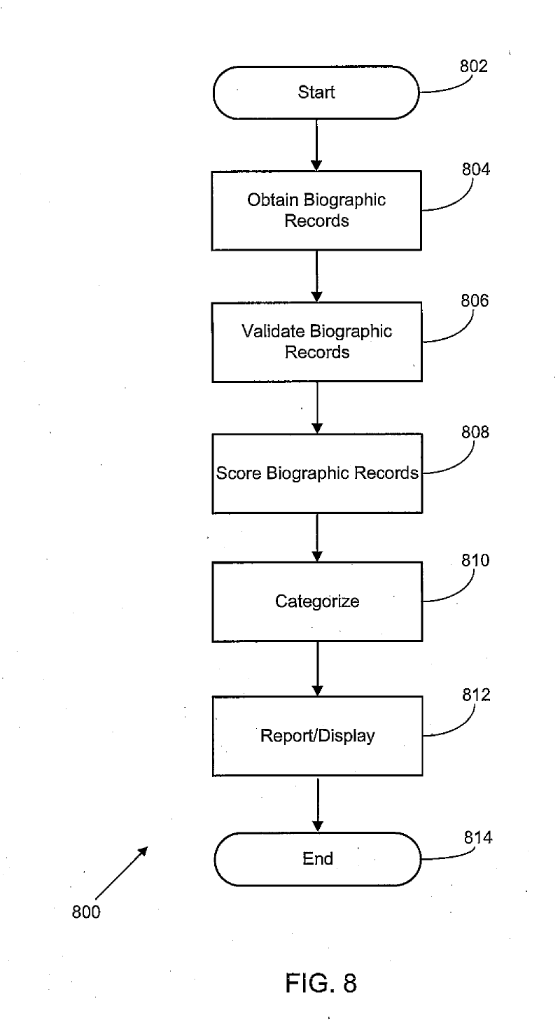

FIG. 8 is a flowchart of methods and systems for identifying citizenship fraud by unauthorized aliens according to a possible embodiment of the present disclosure. The system 800 can be preformed using one or more of the servers, data collections, and user interfaces described in conjunction with FIGS. 1-7. The system 800 is instantiated at a start operation 802, which corresponds to initial setup of a biographic scoring server, including establishing a connection with an inmate data server that holds one or more biographic records.

Operational flow proceeds to a records module 804, which corresponds to the biographic scoring server obtaining one or more biographic records from an external system, such as an biographic data server. The records module 804 can include execution of software including the data interface module 402 of FIG. 4, in accordance with the security systems described in conjunction with FIG. 3.

Operational flow proceeds to a validation module 806, which performs validation of the various biographic records received by the biographic scoring server. The validation module 806 generally corresponds to collection of publicly or commercially available information, such as property records, tax records, employment information, phone number registration information, and other information to determine whether the entries in the biographic record are valid and correct. The validation module 806 can be executed or performed using the biographic scoring server, or can be performed on a computing system external from the biographic scoring server, such as an analysis server as shown in FIG. 1. In embodiments in which validation is performed externally to the biographic scoring server, the validation module 806 coordinates transmission of biographic records and receipt of validation information, in accordance with the data sharing and validation techniques described in conjunction with FIGS. 1 and 3.

Operational flow proceeds to a scoring module 808, which scores each of the biographic records using scoring rules executed by the biographic scoring server. The various scoring rules used, as well as the order and weighting of the rules, can vary in different embodiments, and can be user-editable in certain embodiments of the present disclosure, as previously described. Operational flow proceeds to a categorization module 810, which corresponds to categorizing the various biographic records based on the scores calculated using the scoring module 808. Different methods of categorizing the biographic records could be used; in certain embodiments, the biographic records are categorized into three levels corresponding to a high, medium, and low likelihood that the record corresponds to an individual who is an unauthorized alien/non-citizen of the United States.

A report/display module 812 generates one or more reports based on the scores determined from the biographic records. Sample reports, and user interfaces displaying those reports, are shown in FIGS. 6-7. An end operation 814 signifies completion of at least one instance of the methods and systems of targeting and/or identifying citizenship fraud.

The systems and methods of this disclosure provide a number of operative alternatives to perform a scoring algorithm on biographic records to identify certain records that correspond with individuals who are highly likely to be unauthorized non-citizens of the United States (i.e. unauthorized aliens). Although the specific algorithms are described primarily as being performed in conjunction with certain user interfaces and computing systems, it is understood that the biographic scoring system and the corresponding citizenship fraud targeting system can in fact be executed in a variety of types of networks. Furthermore, and as previously described, systems and methods can be applied consistent with the present disclosure in the context of state and local records, such as are collected in the context of drivers' license applications, mortgage applications, or local applications for municipal services. Other possibilities exist as well.

The above specification, examples and data provide a complete description of the manufacture and use of the composition of the invention. Since many embodiments of the invention can be made without departing from the spirit and scope of the invention, the invention resides in the claims hereinafter appended.

1. A biographic scoring system comprising:
a biographic scoring module that applies one or more scoring rules to each of a plurality of biographic records to generate a score associated with each of the plurality of biographic records;
a result generation module that generates a report based on one or more scores generated by the biographic scoring module
wherein the one or more scores reflect a likelihood that individuals associated with the corresponding biographic records are unauthorized aliens.

2. The biographic scoring system of claim 1, further comprising an data interface module programmed to receive the plurality of biographic records from an biographic data server.

3. The biographic scoring system of claim 1, further comprising a scoring control module allowing a user of the biographic scoring system to modify the one or more scoring rules.

4. The biographic scoring system of claim 3, wherein the scoring control module generates a user interface displaying the one or more scoring rules.

5. The biographic scoring system of claim 1, wherein the report summarizes the scores of a plurality of biographic records.

6. The biographic scoring system of claim 1, wherein the plurality of biographic records includes inmate records received from one or more jails.

7. The biographic scoring system of claim 1, wherein the scoring rules each include a value and a weighting factor.

8. The biographic scoring system of claim 1, further comprising a user interface module programmed to display the report to a user.

9. A citizenship fraud targeting system comprising:
a biographic scoring system communicatively connected to a network, the biographic scoring system configured to receive biographic records from an biographic data server, the biographic scoring system further configured to apply one or more scoring rules to each of a plurality of the biographic records to generate a score associated with each of the plurality of biographic records, the biographic scoring system further configured to generate a report based on one or more scores, wherein the one or more scores reflect a likelihood that individuals associated with the corresponding biographic records are unauthorized aliens.

10. The citizenship fraud targeting system of claim 9, further comprising an analysis system communicatively connected to the biographic scoring system, the analysis system configured to validate at least a portion of the biographic records.

11. The citizenship fraud targeting system of claim 10, wherein the analysis system compares biographic records to public or commercial records.

12. The citizenship fraud targeting system of claim 9, further comprising a biographic data server configured to store biographic records for one or more institutions.

13. The citizenship fraud targeting system of claim 9, further comprising a plurality of workstations communicatively connected to the network, the plurality of workstations capable of accessing the report generated by the biographic scoring system.

14. The citizenship fraud targeting system of claim 9, wherein the inmate scoring system is configured to allow an authorized user of the biographic scoring system to modify the one or more scoring rules.

15. The citizenship fraud targeting system of claim 9, wherein the scoring rules each include a value and a weighting factor.

16. The citizenship fraud targeting system of claim 9, wherein the plurality of biographic records includes inmate records received from one or more jails.

17. A method of identifying unauthorized aliens, the method comprising:
scoring one or more biographic records with one or more scoring rules to generate a score corresponding to each of the one or more biographic records; and
generating a report based on one or more of the scores, the report relating to a likelihood that one or more of the biographic records corresponds to an unauthorized alien.

18. The method of claim 17, further comprising categorizing the one or more biographic records based on the scores.

19. The method of claim 17, further comprising obtaining a plurality of biographic records from an inmate data server.

20. The method of claim 19, further comprising selecting the one or more biographic records from among the plurality of biographic records obtained from the biographic data server.

21. The method of claim 17, further comprising generating a user interface configured to display the report.

22. The method of claim 17, further comprising categorizing the one or more biographic records based on the score corresponding to each of the one or more biographic records.

23. The method of claim 17, further comprising validating the one or more biographic records prior to scoring, wherein validating the one or more biographic records comprises assigning codes to the biographic records based on a correspondence with public or commercial records.

24. The method of claim 17, wherein the plurality of biographic records includes inmate records received from one or more jails.
